(19) United States
(12) Patent Application Publication
(10) Pub. No.: US 2012/0259362 A1
(43) Pub. Date: Oct. 11, 2012

(54) TEETHING AND THUMB SUCKING DEVICE

(76) Inventors: Ann L. Weinland, Parker, CO (US); Kenneth W. Weinland, II, Parker, CO (US)

(21) Appl. No.: 13/084,431

(22) Filed: Apr. 11, 2011

(51) Int. Cl. A61J 17/00

(52) U.S. Cl. 606/235

(57) ABSTRACT

A teething and thumb sucking device that is worn on a hand of an adult is provided. The device includes an elongate tubular body portion and a flare portion. The body portion includes a proximal open end configured to receive a thumb of the adult hand and a distal closed end. The body portion decreases in diameter from the proximal open end to the distal closed end. The flare portion is disposed at the proximal open end of the body portion and extends axially therefrom.

### FIELD OF THE INVENTION

The present invention relates to infant care devices. More specifically, the present invention relates to infant teething devices, and, in particular, to a teething device which may be worn on the thumb or digit of an adult hand.

### BACKGROUND OF THE INVENTION

Human infants at birth typically have no teeth. During the first year of life, an infant's teeth begin to develop, and, as they grow, they break through the gums causing soreness, irritation, itching and inflammation. As anyone who has raised a child knows, an infant going through the teething process experiences considerable oral discomfort, which the infant instinctively attempts to mitigate by sucking or chewing on just about any object it can grasp and insert into its mouth, including toys, teething devices, its own hands and fingers and the fingers and/or thumb of the hand of an adult which may be holding the child. The constant moisture, biting and chewing on the hands, fingers or thumbs of either the infant or and adult can cause considerable irritation and chaffing.

A number of infant teething devices are commercially available which are designed to be grasped by an infant and bitten or chewed, thereby massaging the infant's irritated gums. By way of example, such devices include teething rings and nipples which are familiar to most parents raising young children. However, one difficulty associated with such articles is that an infant's fine motor skills are not sufficiently developed to permit it to place a teether into its mouth and hold it there. They are constantly being dropped and become lost, soiled and generally unsanitary.

One solution to this problem is to provide a teether which may be affixed to a finger or thumb of a teething infant's hand, thereby ensuring that it will not be dropped and soiled. Such a device is disclosed in U.S. Pat. No. 2,688,961 issued Jun. 1, 1953, to Thomas for a “Multipurpose Finger-Attached Accessory”. Other devices include teething mittens for an infant disclosed in U.S. Patent Application Publication No. US2005/0222621 published by Duwelius et al. on Oct. 6, 2005, and in U.S. Patent Publication No. US2006/0004412 published by Gilbert on Jan. 5, 2006. However, these teething devices are intended to protect the hands and fingers of an infant, and are not intended to protect the thumb and/or fingers of an adult holding a teething infant.

Other prior art devices, such as the device disclosed in U.S. Pat. No. 5,010,901 issued Apr. 30, 1991 to Pales, disclose devices which are specifically designed to prevent a wearer or user thereof from sucking his or her thumb. The apparatus of the Pales disclosure does not address the problems associated with an infant's teething on a thumb or finger of an adult which may be holding it.

Accordingly, a need exists for an infant teething device which may be worn on a thumb and/or the fingers of the hands of an adult.

### SUMMARY OF THE INVENTION

It is an object of the present invention to provide a teething and thumb sucking device adapted to fit over either a thumb or finger of an adult hand.

It is a further object of the present invention to provide a teething and thumb sucking device constructed of a material which would provide soothing contact with the infant's gums, prevent saliva from soiling the adult's hands and which would be washable for sanitation purposes.

In order to achieve the above mentioned objects and other objects of the present invention, a teething and thumb sucking device that is worn on a hand of an adult is provided that basically comprises an elongate tubular body portion and a flare portion. The body portion includes a proximal open end configured to receive a thumb of the adult hand and a distal closed end. The body portion decreases in diameter from the proximal open end to the distal closed end. The flare portion is disposed at the proximal open end of the body portion and extends axially therefrom.

These and other objects, features, aspects and advantages of the present invention will become apparent to those skilled in the art from the following detailed description, which, taken in conjunction with the annexed drawings, discloses a preferred embodiments of the present invention.

### BRIEF DESCRIPTION OF THE DRAWINGS

FIG. 1a is a plan view of a human hand depicting the device of the present invention positioned on the thumb;

FIG. 1b is a plan view of a side opposite the side shown in FIG. 1a;

FIG. 2a is a perspective view of a human hand depicting the device of the present invention positioned on the thumb;

FIG. 2b is a plan view of the device of the present invention according to an embodiment;

FIGS. 3a and 3b are side and top plan views of the device of the present invention including a mouth attachment according to an embodiment;

FIG. 3c is a top plan view of the mouth attachment of the embodiment shown in FIGS. 3a and 3b; and

FIGS. 4a-4e are side plan views of alternate configurations of the device of the present invention according to embodiments.

### DESCRIPTION OF THE INVENTION

Before proceeding with the detailed description, it should be noted that the present teaching is by way of example, not by limitation. The concepts herein contained are not limited to use or application of one specific type of teething and thumb sucking device. Thus, although the instrumentalities described herein are for the convenience of explanation, shown and described with respect to exemplary embodiments, the principles herein may be applied equally in other types of teething and thumb sucking devices.

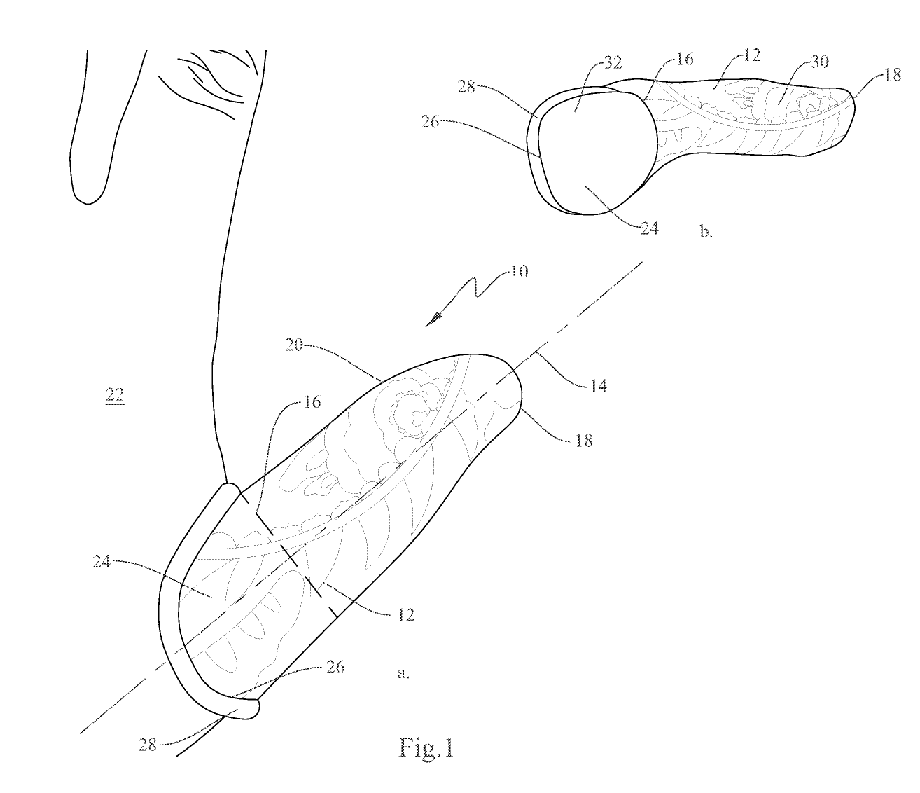

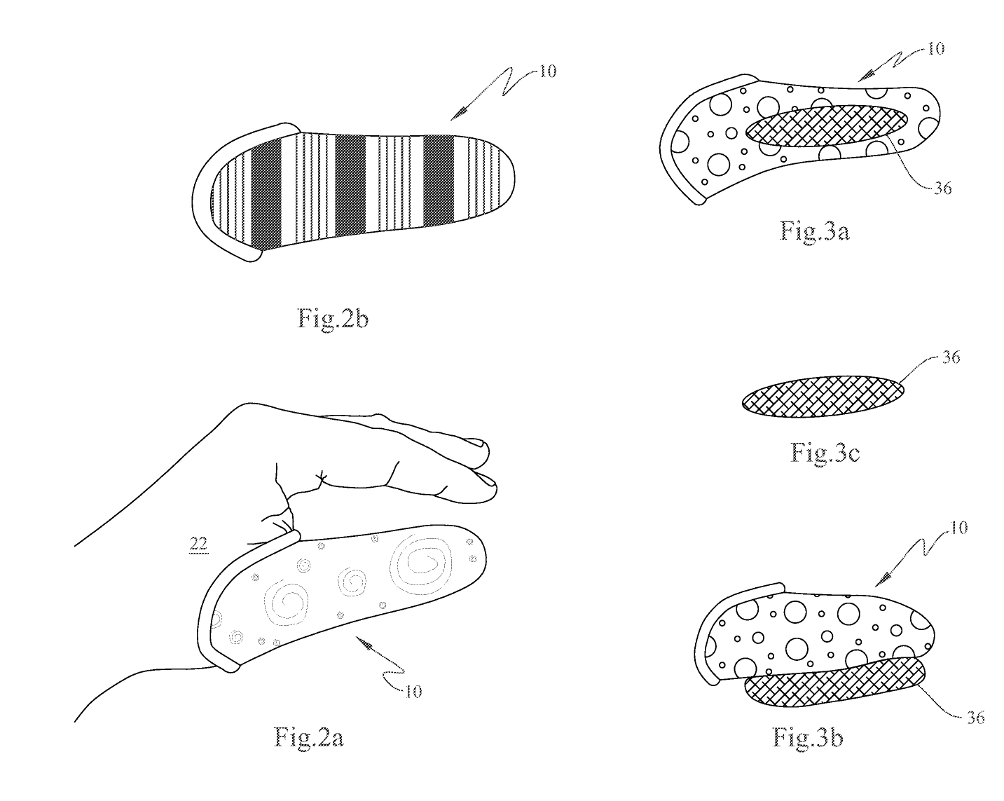

Referring now to FIG. 1, a teething and thumb sucking device (hereinafter, “device”) of the present invention is shown generally at 10. The device includes a generally elongate tubular body portion 12 extending along a longitudinal axis 14. The body portion 12 includes a proximal open end 16 configured to receive a thumb or finger of an adult human hand and a distal closed end 18. The body portion 12 is generally tapered axially and in a diametrically smaller direction from the open end 16 to the closed end 18. In the embodiment shown, the device 10 is fitted over a thumb 20 of a human hand 22; however, it is to be understood that the device could be worn on any of the other fingers without departing from the scope of the present invention.

The device 10 further includes a flare portion 24 connected to the body portion 12 at the proximal open end 16. The flare portion 24 extends axially away from the body portion 12 with an increased width. The flare portion 24 offers additional protection for the adult wearer and more surface area for alternate teething locations. The flare portion 24 can be shaped to curve around the base of the thumb 20. Specifically, the flare portion 24 is configured and arranged relative the body portion 12 to cover a portion of the thumb's 20 metacarpal bone. The flare portion 24 includes an end portion 26 that is configured and arranged such that when the device 10 is worn, the end portion 26 is in proximity to a carpometacorpal joint of the thumb 20. The end portion 26 includes a band member 28 for reinforcing the flare portion 24 where it meets the thumb 20 near the carpometacorpal joint.

The body portion 12 and the flare portion 24 are formed as an integral, unitary, one-piece member to form the device 10. The body portion 12 and the flare portion 24 are preferably made of material that provides a tight fit on the thumb 20. The device 10 does not have the interwoven or braided strips of material disclosed in U.S. Pat. No. 2,688,961.

As depicted in the Figs., the device 10 of the present invention is preferably free from a protrusion that would hinder insertion into the infant's mouth. The device 10 may include various aesthetically-appealing designs, several of which are shown by way of example only and without limitation on the scope of the present invention, which would make the device appealing to an infant for teething and may be manufactured from a number of available materials which are suitable for the intended application. Table 1 below sets forth materials with their explanations that may be used to manufacture the device 10 of the present invention. It is to be understood, however, that the materials listed are by way of example only and not by limitation, and other materials not listed which are suitable for use in the device 10 may also be employed.

TABLE 1

| Material | Explanation |
|---|---|
| aba | garment of camel or goat hair; camel or |
| | goat-hair fabric |
| aerophane | thin crinkled semi-transparent fabric |
| alepine | mixed wool and silk or mohair and cotton |
| | fabric |
| alpaca | fine wool made from alpaca hair |
| angora | silk-like fabric made from wool of angora |
| | goats |
| ardass | fine silk |
| armure | twilled woolen or silk fabric |
| arrasene | embroidery fabric of wool and silk |
| atlas | rich satin fabric |
| baft | cheap coarse cotton fabric |
| bagging | coarse fabric for making bags or sacks |
| baize | coarse napped cotton or wool fabric |
| balbriggan | knitted cotton fabric |
| baldachin | rich embroidered silk and gold fabric |
| balzarine | light cotton dress material |
| barathea | pebbly silk or worsted fabric with broken |
| | rib weave |
| barege | gauzy fabric of silk, cotton, wool, or |
| | worsted |
| barracan | fine silk cloth |
| barras | coarse linen fabric |
| barrateen | some kind of fabric |
| batiste | fine soft sheer fabric of plain weave |
| bayadere | fabric with horizontal stripes in |
| | strongly contrasting colours |
| beaupers | linen fabric used for flags |
| bengaline | crosswise ribbed fabric |
| bombazine | twilled silk and worsted fabric |
| borato | thin fabric |
| bouclé | fabric of uneven looped yarn |
| brilliantine | light lustrous cotton and worsted fabric |
| broadcloth | dense twilled wool or worsted fabric |
| brocade | rich silk fabric with raised patterns |
| buckram | stiff-finished cotton or linen used for |
| | linings of garments |
| bump | coarse cotton fabric |
| bunting | light loosely woven fabric used for |
| | flags |
| burdet | cotton fabric |
| burlap | coarse plain-woven jute or hemp fabric |
| burnet | dark brown; dark woolen cloth |
| burrel | coarse russet cloth |
| calamanco | satin twilled woolen fabric |
| calico | plain white cotton |
| camaca | fine silk fabric |
| cambresine | fine linen fabric |
| cambric | fine thin white cotton or linen fabric |
| camlet | strong waterproof silk or wool fabric |
| caneva | fancy woolen fabric made to resemble |
| | canvas |
| canque | Chinese cotton fabric |
| cashmere | soft twilled fabric made of fine |
| | goat's wool |
| cashmerette | soft imitation of cashmere |
| cassimere | closely woven twilled cloth of fine wool |
| cendal | silk fabric resembling taffeta |
| challis | soft lightweight silk, wool or cotton |
| | fabric |
| chambray | lightweight fabric with coloured warp |
| | and white filling |
| chamois | cotton fabric made in imitation of |
| | chamois leather |
| charmante | silk fabric with a crepe back |
| charmeuse | soft and satiny silk fabric |
| chenille | velvety silk, wool or cotton fabric with |
| | protruding pile |
| cheviot | coarse heavy plain or twilled wool or |
| | worsted |
| chiffon | sheer silk fabric |
| chino | strong twilled cotton cloth |
| chintz | glazed printed cotton fabric |
| cire | fabric with a glazed finish |
| cloque | fabric with an embossed design |
| coburg | thin single-twilled worsted fabric with |
| | cotton or silk |
| cordovan | soft goatskin leather |
| corduroy | durable cotton piled fabric with vertical |
| | ribs |
| crash | coarse drapery and towelling fabric |
| crepe | light crinkled fabric |
| crepon | heavy crepe fabric with lengthwise |
| | crinkles |
| cretonne | heavy cotton or linen cloth |
| crin | horsehair fabric |
| crinoline | stiff flax or cotton fabric |
| cubica | fine unglazed fabric resembling shalloon |
| cypress | silk or cotton gauze fabric, usually |
| | black |
| damask | fine lustrous fabric with flat patterns |
| | and a satin weave |
| delaine | light fabric of wool or mixed wool and |
| | cotton |
| denim | firm and durable twilled cotton |
| dimity | sheer and stout white cotton |
| domett | plain cotton-wool blend |
| dornick | stout linen |
| dowlas | coarse linen |
| drabbet | coarse linen |
| drap-de-Berry | old woolen cloth |
| dreadnought | heavy woolen cloth |
| drill | durable twilled cotton |
| droguet | ribbed woolen dress fabric |
| drugget | coarse durable wool fabric |
| ducape | plain-woven stout silk fabric |
| duck | durable closely woven cotton fabric |
| duffel | fabric of thick, low-quality woolen |
| | cloth |
| dungaree | heavy coarse durable twilled cotton, |
| | usually coloured |
| dupion | coarse silk |
| duroy | coarse woolen |
| duvetyn | smooth lustrous velvety fabric |
| ecarlate | fine woolen cloth, usually dyed scarlet |
| éolienne | fine silk and wool |
| etamine | light open-mesh cotton or worsted |
| eyelet | small hole in fabric to allow passage of |
| | a cord; cotton fabric with small holes |
| faille | shiny closely woven silk, cotton or |
| | rayon fabric |
| farandine | silk and wool cloth |
| filoselle | coarse floss silk |
| flannel | light woolen fabric |
| foulard | soft lightweight plain-woven or twilled |
| | silk fabric |
| foulé | light woolen fulled cloth |
| frieze | rough heavy woolen cloth |
| fuji | plain spun silk fabric |
| fustian | coarse twilled cotton |
| gabardine | closely woven cotton or wool twill |
| galatea | striped cotton |
| gambroon | twilled worsted and cloth |
| gazar | silk organza fabric |
| genappe | smooth worsted yarn |
| georgette | thin silk |
| gingham | striped cotton cloth |
| grenadine | thin silk |
| grogram | coarse loosely woven silk fabric |
| grosgrain | heavy close-woven corded silk |
| gulix | kind of fine linen |
| harn | coarse linen |
| herringbone | twilled fabric woven in rows of parallel |
| | sloping lines |
| hodden | coarse undyed woolen cloth |
| holland | coarse plain-woven cotton or linen |
| hopsack | rough-surfaced loose fabric |
| houndstooth | fabric with an irregular checked pattern |
| huckaback | absorbent cotton or linen used for towels |
| jaconet | stout cotton cloth |
| jacquard | intricately-woven variegated fabric; |
| | loom for making jacquard |
| jaspe | cotton or rayon cloth with shaded effect |
| jean | durable twilled cotton material |
| jersey | plain weft-knitted fabric of wool, |
| | cotton, nylon or silk |
| kalamkari | fabric coloured by repeated dyeing |
| kelt | coarse fabric made of black and white |
| | wool |
| kente | hand-woven African silk fabric |
| kersey | coarse woolen cloth |
| kerseymere | twilled fine wool |
| khaddar | homespun cotton cloth |
| kincob | embroidered silk with gold and silver |
| | threads |
| lamé | fabric in which metallic threads are |
| | interwoven |
| lasting | sturdy cotton or worsted cloth |
| lawn | fine sheer plain-woven cotton or linen |
| leno | open-woven fabric |
| linsey | coarse linen and wool blend |
| linsey-woolsey | thin coarse fabric of wool and linen |
| lockram | coarse linen |
| loden | heavy waterproof woolen fabric |
| lustring | glossy silk |
| lutestring | plain glossy silk |
| mackinaw | heavy napped and felted wool cloth |
| mackintosh | lightweight rubberized waterproof cotton |
| madapollam | fine cotton cloth |
| madras | fine plain-woven cotton or silk |
| marabout | thin downy silk |
| marcella | cotton or linen in twill weave |
| marocain | ribbed crepe fabric |
| marquisette | sheer meshed cloth |
| matelassé | having a quilted ornamentation; fabric |
| | with raised pattern as if quilted |
| melton | strong and smooth heavy woolen cloth |
| merino | soft wool of the merino sheep; any soft |
| | merino-like wool or wool and cotton cloth |
| messaline | soft lightweight silk with a satin weave |
| mockado | inferior quality woolen fabric |
| mogadore | ribbed silk used in making neckties |
| mohair | fabric made from silky hair of angora |
| | goats |
| moire | watered silk |
| moleskin | heavy durable cotton |
| moreen | stout corded wool or cotton |
| mousseline | fine sheer fabric |
| mull | soft fine sheer cotton or silk fabric |
| muslin | plain-woven fine cotton |
| musterdevillers | archaic mixed grey woolen cloth |
| nainsook | fine cotton fabric |
| nankeen | buff-coloured; durable buff-coloured |
| | cotton |
| needlecord | thinly ribbed cotton |
| ninon | silk voile or other thin fabric |
| organdie | fine translucent cotton |
| organza | transparent thin silk or nylon |
| orleans | interwoven cotton and worsted |
| osnaburg | coarse linen or cotton |
| ottoman | heavy clothing fabric with crosswise ribs |
| oxford | soft durable plain-woven cotton |
| paduasoy | corded silk |
| paisley | soft wool fabric with ornamental pattern |
| panne | heavy lustrous silk or rayon with waxy |
| | feel |
| paramatta | worsted and cotton blend |
| pashmina | fine goat's wool fabric used for |
| | making shawls |
| pekin | fine soft silk |
| pellicule | thin diaphanous fabric |
| percale | closely woven lightweight cloth |
| percaline | glossy lightweight cotton |
| perse | dark blue or bluish-grey; cloth of such |
| | a colour |
| piqué | stiff durable corded fabric of cotton, |
| | rayon or silk |
| platilla | fine white linen |
| plissé | fabric with puckered finish |
| pongee | thin soft fabric woven from raw silk |
| poodle | coarsely looped or nubby fabric |
| poplin | corded woven silk and worsted |
| prunella | strong and heavy silk or wool |
| rabanna | raffia fabric of Madagascar |
| ramie | strong lustrous fabric resembling linen |
| | or silk |
| raploch | coarse undyed woolen cloth |
| raschel | light loosely kitted cloth |
| ratiné | rough bulky plain-woven fabric |
| rep | plain-woven fabric with crosswise ribs |
| reticella | old Venetian lace-like fabric |
| romal | handkerchief or headcloth; silk or |
| | cotton fabric |
| rumchunder | fine silk |
| russel | ribbed cotton and wool |
| russet | coarse homespun cloth |
| sagathy | light blend of silk and cotton or wool |
| samite | rich and heavy silk, sometimes interwoven |
| | with gold or silver |
| sarsenet | fine and soft silk; soft or gentle |
| satara | ribbed lustred wool |
| sateen | glossy cotton or wool |
| satin | closely woven silk with lustrous face |
| satinet | thin silk satin or imitation thereof |
| saxony | fine soft woolen fabric |
| say | delicate woolen fabric |
| scarlet | fine cloth |
| scrim | durable plain-woven cotton fabric |
| seersucker | light puckered cotton or linen fabric |
| sempiternum | durable wool |
| sendal | thin silk or linen |
| serge | strong twilled worsted |
| shalloon | light twilled wool or worsted |
| shantung | plain rough silk or cotton |
| sharkskin | smooth durable wool or worsted fabric |
| shetland | lightweight loosely twisted wool fabric |
| shoddy | woolen fabric made from rags |
| sicilienne | ribbed silk |
| silesia | thin twilled cotton or linen |
| silkaline | soft light cotton fabric resembling silk |
| sindon | fine linen |
| stammel | coarse woolen fabric, usually dyed red; |
| | bright red colour |
| stockinette | soft elastic cotton fabric |
| surah | soft twilled silk or rayon |
| swansdown | heavy napped cotton flannel |
| swanskin | soft napped fabric resembling flannel |
| tabaret | striped watered silk and satin fabric |
| tabby | plain-woven silk taffeta fabric |
| tabinet | silk and wool watered fabric |
| taffeta | thin glossy silk |
| tamin | thin glazed worsted |
| tamis | thin wool |
| tarlatan | thin sheer stiff cotton |
| terry | piled fabric consisting of uncut loops |
| ticking | strong linen or cotton fabric used for |
| | mattress and pillow cases |
| tiffany | transparent silk-like gauzy fabric |
| tiretaine | wool cloth mixed with cotton or linen |
| toile | plain or simple twilled fabric |
| tricolette | silk or rayon knitted fabric |
| tricot | plain knitted silk or woolen fabric |
| tricotine | double-twilled worsted fabric |
| tulle | sheer and delicate thin silk |
| tussah | brownish silk fabric |
| tweed | rough twilled wool |
| twill | any diagonally woven fabric |
| velour | piled velvety cotton |
| veloutine | velvety corded wool |
| velvet | soft piled fabric of silk, cotton or |
| | synthetic material |
| velvetine | cotton with silk pile |
| vicuna | fabric made from wool of the vicuna, |
| | a small ruminant |
| voile | soft fine sheer fabric |
| wadmal | thick coarse wool |
| whipcord | fabric with bold twill used for making |
| | dresses |
| wigan | stiff plain-woven cotton |
| wincey | plain or twilled cotton |
| woolsey | cotton and wool blend |
| worcester | fine wool |
| worsted | fine closely-woven wool |
| zanella | mixed twilled umbrella fabric |
| zephyr | lightweight wool or worsted fabric; |
| | the west wind |
| zibeline | soft piled wool |
| Birdseye Fabric | Gauzy Material |
| Hemp | Fiber made from hemp plant |
| Hemp French Terry | Made with absorbent hemp |
| Bamboo | Made from Bamboo trees |
| Cotton Fleece | Super soft fabric that is comparable to |
| | polyester |
| Flannel | Soft, loosely woven twill weave—Cotton |
| | or Wool |
| Merino | Wool |
| Polyester | |
| Terry Cloth | |
| Stretch Knit Terry | |
| Wool | |
| Sherpa | |
| Suedecloth | |
| Microfleece | |
| Velour | |
| Burley Knit Terry | |
| Windpro | |
| Old Weavers Organic Fabrics | 100% organic and FDA certified |

From a sanitary perspective, it is desirable that the device 10 include a moisture-proof barrier between the infant's mouth and the skin of the finger or thumb 20 on which the device 10 is worn to prevent harmful bacteria and/or germs which may be present on the hand from entering the infant's mouth, and to prevent bacteria and germs from the infant's mouth from coming into contact with the hand. The outer surface layer 30 and the inner surface layer 32 may be layered together with the moisture-proof barrier. Alternatively, the outer surface layer 30 and the inner surface layer 32 can form an integral, unitary, one-piece layer that integrates the moisture-proof barrier. The moisture or water proof barrier may alternatively be sewn into the outer surface layer 30 by ordinary stitching/sewing techniques. By way of illustration and not limitation, examples of materials which may be used for this barrier are set forth in Table 2 below; however, other suitable materials may also be employed in this application without departing from the scope of the present invention.

TABLE 2

Polyurethane Laminate (cloth baby diapers)
Nylon Ripstop: Breathable
Nylon Ripstop: Coated
Nylon Taffeta: Breathable
Polyester Microfiber: Breathable
Epic encapsulated water-resistant
Goretex
Entrant 100% Nylon Fiber
Ultrex: 100% Nylon Fiber
Generic water-resistant fiber

Referring now to FIG. 3, an embodiment of the device 10′ is shown which includes a mouth attachment 36. The mouth attachment 36 may be formed of the same material as the teething and thumb sucking device 10′ and may be filled with a foam material, a soft cotton, a soft rubber or other suitable elastomeric material adapted to provide comfort to an infant's irritated gums and newly emerging teeth when chewed or bitten down upon.

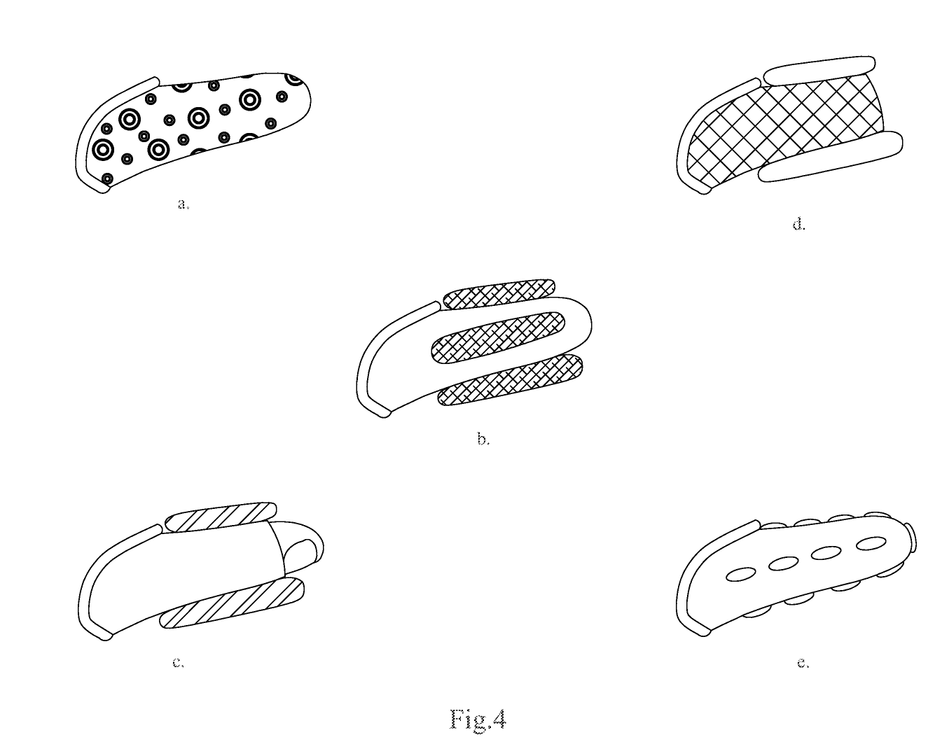

FIGS. 4a-4e illustrate yet other embodiments of the device of the present invention depicting alternative choices of decorative patterns (FIG. 4a); four mouthpieces positioned longitudinally along the body of the device at approximately ninety degree) (90° intervals (FIG. 4b); two mouthpieces positioned longitudinally along the body of the device at approximately one hundred eighty degree (180°) intervals (FIG. 4c); in the embodiment of FIG. 4d, the device of FIG. 4c is shown constructed of leather material.

In the embodiment of FIG. 4e, substantially aligned, spaced apart ribbed protrusion members 34 for massaging the teeth and gums are disposed at the outer surface layer 30 on the body portion 12 and the flare portion 24. The protrusion members 34 are positioned longitudinally along the body of the device at approximately ninety degree (90°) intervals. The device 10 of FIG. 43 is preferably made of an elastomeric material. The outer surface layer 30 is generally rough to engage the infant's gums and provide some relief from teething. The inner surface layer 32 is generally smooth for a comfortable fit on the thumb 20; however, the inner surface layer 32 could have a few traction members if further stabilizing on the thumb 20 is desired. It will be apparent to one of ordinary skill in the art from this disclosure that the protrusion members 34 can be different shapes and sizes to form various aesthetically-appealing designs to make the device 10 appealing to an infant for teething and may be manufactured from a number of available materials which are suitable for the intended application.

Still referring to the embodiment of FIG. 4e, the protrusion members 34 are carved, etched or molded, for example, into the outer surface layer 30 to form an uneven surface. The carving, etching or molding can even form the protrusion members 34 into an aesthetically-appealing design pattern. While the protrusion members 34 extend outwardly from the body portion 12 and the flare portion 24, the protrusion members 34 are small enough to not impede insertion of the device 10 into the infant's mouth. The device 10 of the present invention is preferably free from a protrusion that would hinder insertion into the infant's mouth.

Changes may be made to the above methods, systems, devices and materials without departing from the scope hereof. It should be noted that the matter contained in the above description and/or shown in the accompanying drawings should be interpreted as illustrative and not in a limiting sense. The following claims are intended to cover all generic and specific features described herein as well as statements of the scope of the present invention, which, as a matter of language, might be said to fall therebetween.

What is claimed is:

1. A teething and thumb sucking device worn on a hand of an adult comprising:
an elongate tubular body portion including a proximal open end configured to receive a thumb of the adult hand and a distal closed end, the body portion decreasing in diameter from the proximal open end to the distal closed end; and
a flare portion disposed at the proximal open end of the body portion and extending axially therefrom.

2. The teething device of claim 1, further comprising a moisture proof barrier at the body portion and the flare portion.

3. The teething device of claim 1, wherein the flare portion is configured and arranged to curve around the base of the thumb.

4. The teething device of claim 1, wherein the body portion and the flare portion are formed as an integral, unitary, one-piece member.

5. The teething device of claim 1, wherein the body portion and the flare portion are made of wool or a wool blend.

6. The teething device of claim 1, wherein the body portion and the flare portion are made of cotton or a cotton blend.

7. The teething device of claim 1, wherein the body portion and the flare portion are made of silk.

8. The teething device of claim 1, wherein the body portion and the flare portion are made of leather.

9. The teething device of claim 1, wherein the body portion and the flare portion are made of rayon.

10. The teething device of claim 1, wherein the body portion and the flare portion are made of hemp fibers.

11. The teething device of claim 1, wherein the body portion and the flare portion are made of bamboo.

12. The teething device of claim 1, further comprising a plurality of protrusions on the body portion and the flare portion.

13. The teething device of claim 1, wherein the protrusions are configured and arranged to engage an infant's gums but not to impede insertion into the infant's mouth.
